(19) United States
(12) Patent Application Publication
(10) Pub. No.: US 2009/0220667 A1
(43) Pub. Date: Sep. 3, 2009

(54) Herbal formulations and methods for supplementing caffeinated beverages

(76) Inventor: Daniel Johnson, Santa Cruz, CA (US)

Correspondence Address: MAIER & MAIER, PLLC, 1000 DUKE STREET, ALEXANDRIA, VA, 22314, US

(21) Appl. No.: 12/073,204

(22) Filed: Mar. 3, 2008

(51) Int. Cl. A23F 5/00; A23L 2/52; A23L 1/30

(52) U.S. Cl. 426/595; 426/590; 426/648

(57) ABSTRACT

Herbal formulations for use in caffeinated beverages are disclosed. A formulation for improving cognitive functions can include Ganoderma lucidum, Semen Zizyphi Spinosae, Herba Cistanches, Gastrodia Elata and Rhizoma Polygonati. A formulation for promoting digestive functions can include Radix Astragali, Rhizoma Dioscoreae, Radix Codonopsis, Fructus Setariae Germinatus, Radix Gentianae and Glycyrrhiza uralensis. A formulation for mitigating undesired effects of the caffeinated beverage can include Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis. A formulation for promoting healthy reactions to stress can include Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae. A formulation for improving immune system functions can include Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae.

### BACKGROUND

Caffeine serves as a stimulant and relatively mild diuretic at normal dosages in humans. Caffeine is chemically identified as 1,3,7-trimethylxanthine. Humans typically consume caffeine to temporarily increase mental alertness and/or temporarily reduce physical fatigue. Caffeine temporarily increases both mental alertness and reduces physical fatigue rather well when used as intended. Nevertheless, many people who have consumed caffeine at varying dosages have experienced undesirable effects. Such effects include irritability, anxiety, restlessness, insomnia, diuresis, diarrhea, facial flushing, trembling, rapid heartbeat and palpitations, among others.

Caffeinated beverages are the typical and most widely consumed source of caffeine for humans. Caffeinated beverages include coffee beverages, tea beverages, soft drinks and energy drinks. Worldwide and particularly in the United States, coffee beverages are presently the most popular source of caffeine for humans. Coffee beverages are prepared from the roasted seeds, commonly called coffee beans, of coffee plants. Coffee berries contain the coffee beans and are produced by numerous species of the genus Coffea. The two most commonly and commercially important species are C. canephora and C. arabica. All coffee beverages are prepared from processed and roasted coffee beans, but several methods for preparing coffee beverages are popular.

Nevertheless, all popular methods of preparing coffee beverages require that the coffee beans are grounded and roasted before a liquid caffeinated beverage is made therefrom. Coffee beverages are brewed by percolated, pressured and steeped preparation methods. Coffee machines, such as percolators, make use of gravity in brewing coffee beverages (“drip” coffee beverages) where, in the simplest implementation, heated (e.g., boiling) water drips onto coffee grounds held in a coffee filter before the liquid is passed by gravity into a collecting vessel. On the other hand, the espresso method forces hot, but not boiling, pressurized water through coffee grounds. The espresso method produces a more concentrated beverage. As another alternative, coffee beverages brewed by steeping often rely on coffee grounds and heated water being combined in a coffee press (e.g., French press) and left to brew until a plunger is used to separate the liquid from the contacted coffee grounds. This method also typically produces a more concentrated beverage then coffee beverages produced through percolation. An eight ounce cup of conventional “drip” coffee typically contains somewhere between about 50 mg and 200 mg of caffeine, or more. Coffee beverages are also made by reconstituting dehydrated or concentrated coffee beverages with heated water.

After and sometimes during the preparation of coffee beverages and other caffeinated beverages, it is commonplace to provide additional conventional ingredients into the beverages. For example, cream or milk of various fat contents is often added to coffee and tea beverages. Steamed milk is used to prepare lafte beverages. Cream or milk substitutes, such as commercially available creamers, which may be non-dairy, are also commonly added. For many caffeinated beverage drinkers, dairy additives or substitutes impart a pleasant taste, reduce the bitterness of some beverage brews and act to somewhat decrease the temperature of the caffeinated beverages. Sugar and other sweeteners in many forms are also commonly added ingredients for improving the taste by reducing the bitterness of some beverage brews. Other non-conventional additives have been suggested or used for several reasons.

Traditional Chinese Medicine (“TCM”) is considered a complementary or alternative medical system throughout most of the world in relation to western medicine. Many modern practitioners use TCM methods in combination with western methods. TCM includes, depending on one's definition, several sub-practices, such as herbal medicine practices (also known as materia medica, zhōngyào xué, etc.), acupuncture practices, moxibustion practices, food therapy practices, message therapy practices (tui na), breathing and meditation exercises and practices (qigong), trauma injury healing practices (tieh ta), physical exercises and practices (tai chi ch′uan and other martial arts), and mental health therapies and practices (e.g., feng shui and Chinese astrology).

Chinese herbal medicine, which relies on the Chinese art of combining medicinal herbs, known as herbology, is traditionally and presently considered by many to be one of the more important practices of TCM. There has been and there continues to be significant scientific investigation into traditional herbal medicine, which often attempts to reconcile Chinese herbal medicine (and the knowledge and practices thereof) with western medical practices and know-how. Medicinal herbs, which are not necessarily “herbs” in the culinary sense, are traditionally administered by brewing patient-specific mixtures of herbs for ingestion. Many medicinal herbs are commercially available for ingesting alone or in combination with other herbs and non-herbs. The commercially available medicinal herbs retain or do not significant deviate from their traditionally and specific preparations, although many more broadly commercialized herb products make use of many modern techniques in their cultivation, processing and preparation.

### SUMMARY

According to at least one exemplary embodiment, a composition for provisioning to a caffeinated beverage is disclosed. The composition is characterized by an herbal formulation. The herbal formulation can include Ganoderma lucidum, Semen Zizyphi Spinosae, Herba Cistanches, Gastrodia Elata and Rhizoma Polygonati. In another exemplary embodiment, a caffeinated composition having an herbal formulation and a caffeinated beverage where the herbal formulation is provided in the caffeinated beverage is disclosed. The herbal formulation can include Ganoderma lucidum, Semen Zizyphi Spinosae, Herba Cistanches, Gastrodia Elata and Rhizoma Polygonati. In yet another exemplary embodiment, a method of providing an herbal formulation to a caffeinated beverage is disclosed. The method is characterized by preparing an herbal formulation and adding the herbal formulation to a caffeinated beverage. The herbal formulation can include Ganoderma lucidum, Semen Zizyphi Spinosae, Herba Cistanches, Gastrodia Elata and Rhizoma Polygonati.

According to at least one other exemplary embodiment, a composition for provisioning to a caffeinated beverage is disclosed. The composition is characterized by an herbal formulation. The herbal formulation can include Radix Astragali, Rhizoma Dioscoreae, Radix Codonopsis, Fructus Setariae Germinatus, Radix Gentianae and Glycyrrhiza uralensis. In another exemplary embodiment, a caffeinated composition having an herbal formulation and a caffeinated beverage where the herbal formulation is provided in the caffeinated beverage is disclosed. The herbal formulation can include Radix Astragali, Rhizoma Dioscoreae, Radix Codonopsis, Fructus Setariae Germinatus, Radix Gentianae and Glycyrrhiza uralensis. In yet another exemplary embodiment, a method of providing an herbal formulation to a caffeinated beverage is disclosed. The method is characterized by preparing an herbal formulation and adding the herbal formulation to a caffeinated beverage. The herbal formulation can include Radix Astragali, Rhizoma Dioscoreae, Radix Codonopsis, Fructus Setariae Germinatus, Radix Gentianae and Glycyrrhiza uralensis.

According to at least one other exemplary embodiment, a composition for provisioning to a caffeinated beverage is disclosed. The composition is characterized by an herbal formulation. The herbal formulation can include Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis. In another exemplary embodiment, a caffeinated composition having an herbal formulation and a caffeinated beverage where the herbal formulation is provided in the caffeinated beverage is disclosed. The herbal formulation can include Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis. In yet another exemplary embodiment, a method of providing an herbal formulation to a caffeinated beverage is disclosed. The method is characterized by preparing an herbal formulation and adding the herbal formulation to a caffeinated beverage. The herbal formulation can include Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis.

According to at least one other exemplary embodiment, a composition for provisioning to a caffeinated beverage is disclosed. The composition is characterized by an herbal formulation. The herbal formulation can include Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae. In another exemplary embodiment, a caffeinated composition having an herbal formulation and a caffeinated beverage where the herbal formulation is provided in the caffeinated beverage is disclosed. The herbal formulation can include Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae. In yet another exemplary embodiment, a method of providing an herbal formulation to a caffeinated beverage is disclosed. The method is characterized by preparing an herbal formulation and adding the herbal formulation to a caffeinated beverage. The herbal formulation can include Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae.

According to at least one other exemplary embodiment, a composition for provisioning to a caffeinated beverage is disclosed. The composition is characterized by an herbal formulation. The herbal formulation can include Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae. In another exemplary embodiment, a caffeinated composition having an herbal formulation and a caffeinated beverage where the herbal formulation is provided in the caffeinated beverage is disclosed. The herbal formulation can include Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae. In yet another exemplary embodiment, a method of providing an herbal formulation to a caffeinated beverage is disclosed. The method is characterized by preparing an herbal formulation and adding the herbal formulation to a caffeinated beverage. The herbal formulation can include Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

The following description directed to the medicinal properties of individual herbs and mixture of herbs is based, at least in part, on the teachings of Traditional Chinese Medicine (“TCM”). As such, the properties attributed to the individual herbs and mixtures of herbs set forth herein are done so in a non-limiting manner. Any evidence to the contrary based on other understandings or changes in understanding regarding TCM, or past and future scientific research will not operate to affect the operability of embodiments set forth and claimed herein, as will be readily recognized by one having ordinary skill in the art.

Exemplary embodiments described in more detail below can be applied to caffeinated beverages and their decaffeinated counterparts. Exemplary embodiments will be described below in relation to caffeinated beverages, but it is contemplated that such descriptions can be equally applied to their decaffeinated counterparts where appropriate, as will be readily recognized by one having ordinary skill in the art.

In at least one exemplary embodiment, the herbal formulations, when in use, can be applied to any conventional caffeinated or decaffeinated coffee beverages. Because exemplary embodiments are based on the teachings of TCM and because coffee beans are natural ingredients, coffee beans can be viewed within the framework and principles of TCM.

Exemplary embodiments can be composed that will not substantially alter the flavor characteristics (taste characteristics) of coffee beverages when provided thereto, which is described in more detail below in relation to certain exemplary embodiments. Also, herbal formulations described herein can make use of brewed caffeinated beverages, such as coffee beverages, as a medium for administration, which is particularly appropriate given the popularity of such beverages. As such, embodiments can be consumed in a manner that many people are already accustomed to using as a source of caffeine. Embodiments can be selected that counteract one or more of the undesirable effects of caffeine consumption. Embodiments can also be selected to provide a drinker medicinal benefits even if a drinker only consumes one caffeinated beverage daily while embodiments can be sufficiently safe for those who regularly consume more than one caffeinated beverage daily.

Exemplary embodiments can be provided to caffeinated beverages pre-brew, during brewing and post-brew. For non-brewed or cooled (previously brewed) caffeinated beverages, exemplary embodiments can be provided to the caffeinated beverages by heating the beverages to a suitable temperature for adding the herbal formulations and by any other method known to one having ordinary skill in the art. In at least one exemplary embodiment, herbal formulations can be provided to post-brew caffeinated beverages by substantially dissolving the herbal formulation into the caffeinated beverage when the caffeinated beverage is at a suitable temperature. Recently brewed (i.e. prior to substantial cooling) caffeinated beverages, such as coffee and tea beverages directly or shortly after they have been prepared by conventional preparation methods, will typically be at a suitable temperature for dissolution.

In at least one other exemplary embodiment, herbal formulations can be provided to caffeinated beverage precursors, such as coffee beans and coffee grounds, before preparation (e.g., pre-brew). Upon preparation (e.g., brewing) the herbal formulations can be provided (e.g., by substantial dissolution) into the prepared caffeinated beverage. In yet at least one other exemplary embodiment, herbal formulations can be brewed substantially in parallel with the preparation of a caffeinated beverage, and provided (e.g., mixed hot) to the caffeinated beverage during or shortly after preparation. Other means for provisioning herbal formulations to caffeinated beverages will be readily recognized by one having ordinary skill in the art having the benefit of the present disclosure.

In accordance with exemplary embodiments, herbal formulations can be contained within a capsule, a tablet, a pill, a tincture, a bag, an injection, a powder, a granule extract, a liquid extract and any other suitable form of administration known to one having ordinary skill in the art. In at least one exemplary embodiment, herbal formulations provided in such forms can be dissolved in a brewed caffeinated beverage post-brew. In other exemplary embodiments, herbal formulations can exist in wholly herbal form. In other embodiments, herbal formulations can be mixed, for example, with roasted coffee beans or grounds. Exemplary embodiments can be prepared in a scalable fashion and can be separated into any desired dosage (e.g., single dosages). Desired dosages can be packaged in numerous forms for distribution that can be dependent upon the form the herbal formulations are contained within, if any. For example, herbal formulations in single dosages can be packaged in single-serving paper packets and plastic holders, which may be similar in construction to conventional single-serving sugar packets and “half-and-half” holders, as a couple non-limiting examples.

In at least one first exemplary embodiment, herbal formulations including one or more of Ganoderma lucidum, Semen Zizyphi Spinosae, Herba Cistanches, Gastrodia Elata and Rhizoma Polygonati are disclosed. In at least one exemplary embodiment, herbal formulations can be prepared to increase cognitive function when consumed/ingested using, for example, caffeinated beverages as the medium for administration. Herbal formulations may accomplish one or more of improving mental concentration, improving mental acuity, improving memory and improving cognitive clarity (and processes), among other potential benefits.

The following one or more exemplary embodiments include all of Ganoderma lucidum, Semen Zizyphi Spinosae, Herba Cistanches, Gastrodia Elata and Rhizoma Polygonati in the following proportions.

TABLE 1

| Herb | % of formulation by weight |
|---|---|
| Ganoderma lucidum | 15-65 |
| Semen Zizyphi Spinosae | 05-30 |
| Herba Cistances | 04-15 |
| Gastrodia Elata | 05-15 |
| Rhizoma Polygonati | 05-15 |

In at least one exemplary embodiment, a therapeutic amount (dosage) of an herbal formulation can be between about 0.5 and 1.5 grams per eight to twelve ounces of conventional “drip” coffee. Furthermore, a therapeutic amount of an herbal formulation can be about one gram per eight to twelve ounces of conventional “drip” coffee. Herbal formulations prepared as described directly above may less-than-substantially alter the flavor characteristics of conventional coffee beverages. For example, when provided to eight to twelve ounces of conventional “drip” coffee, the taste characteristics of the coffee beverage can only be slightly altered, if at all, as discernable by the typical human sense of taste.

In accordance with the teachings of TCM, Ganoderma lucidum (ling zhi, reishi mushroom) acts to increase memory and reduce forgetfulness. This may be due, at least in part, to anti-inflammatory properties of Ganoderma lucidum. It also is bitter in taste, and can be selected for the above reasons and its ability to blend with the flavor characteristics of coffee beverages.

In accordance with the teachings of TCM, Semen Zizyphi Spinosae (suan zao ren) acts to supplement/build blood. Caffeinated beverages, particularly coffee beverages, are diuretics and can lead to lower levels of blood and other fluids. Semen Zizyphi Spinosae can be selected to counteract these effects.

In accordance with the teachings of TCM, Herba Cistanches (rou cong rong) is traditionally included in the Bu Nao Wan traditional herbal formulation. That formulation acts to supplement cognitive functionality. Although, in exemplary embodiments, Herba Cistanches can also be selected because of its coffee-complementary flavor characteristics.

In accordance with the teachings of TCM, Gastrodia Elata (tian ma) acts to improve cognitive functionality and reduce trembling, convulsions and the like. It can be selected to generally improve cognitive functionality and/or reduce any caffeine-induced trembling.

In accordance with the teachings of TCM, Rhizoma Polygonati (huang jing) acts to provide a deeper and longer lasting energy boost than caffeine and stimulants generally. It is considered a restorative herb and can be selected to increase mental alertness and/ or to reduce physical fatigue.

In at least one second exemplary embodiment, herbal formulations including one or more of Radix Astragali, Rhizoma Dioscoreae, Radix Codonopsis, Fructus Setariae Germinatus, Radix Gentianae and Glycyrrhiza uralensis are disclosed. In at least one exemplary embodiment, herbal formulations can be prepared to promote digestive functions when consumed/ingested using, for example, caffeinated beverages as the medium for administration. Herbal formulations may accomplish one or more of reduce or relieve chronic indigestion, reduce gas, reduce instances of heartburn, reduce or relieve irritable bowel syndrome, counteract poor appetite and promote comfort and health generally, among other potential benefits. Results, if any, are more likely to be realized after about three weeks of daily or almost daily use.

The following one or more exemplary embodiments include all of Radix Astragali, Rhizoma Dioscoreae, Radix Codonopsis, Fructus Setariae Germinatus, Radix Gentianae and Glycyrrhiza uralensis in the following proportions.

TABLE 2

| Herb | % of formulation by weight |
|---|---|
| Radix Astragali | 20-60 |
| Rhizoma Dioscoreae | 05-20 |
| Radix Codonopsis | 20-50 |
| Fructus Setariae Germinatus | 02-10 |
| Radix Gentianae | 02-10 |
| Glycyrrhiza uralensis | 02-10 |

In at least one exemplary embodiment, a therapeutic amount (dosage) of an herbal formulation can be between about 0.5 and 1.5 grams per eight to twelve ounces of conventional “drip” coffee. Furthermore, a therapeutic amount of an herbal formulation can be about one gram per eight to twelve ounces of conventional “drip” coffee. Herbal formulations prepared as described directly above may less-than-substantially alter the flavor characteristics of conventional coffee beverages. For example, when provided to eight to twelve ounces of conventional “drip” coffee, the taste characteristics of the coffee beverage can only be slightly altered, if at all, as discernable by the typical human sense of taste.

In accordance with the teachings of TCM, Radix Astragali (huang qi) acts to reduce weakness, promote proper digestion and strengthen the immune system. It is generally regarded as relatively mild in potency and safe as evidenced by widespread use throughout the world.

In accordance with the teachings of TCM, Rhizoma Dioscoreae (shan yao) acts to promote proper digestion. It can be selected because of its mild taste and food-like properties.

In accordance with the teachings of TCM, Radix Codonopsis (dang shen) acts to increase energy, firm stools and counteract poor appetite. It can be selected because it is similar in function to ginseng root, but considered milder and safer.

In accordance with the teachings of TCM, Fructus Setariae Germinatus (gu ya) acts to aid digestion. Particularly, it can assist the body in breaking down carbohydrates, which may be selected because many people consume coffee beverages with food, such as carbohydrate-rich pastries, bagels, donuts and the like.

In accordance with the teachings of TCM, Radix Gentianae (long dan cao) acts to stimulate bile secretion due to its bitter properties. It can be selected because its generally cooling and bitter nature can balance the generally warming energetic nature of coffee beverages.

In accordance with the teachings of TCM, Glycyrrhiza uralensis (gan cao) is one of, if not the most, commonly used herb in Chinese herbal medicine. It is believed to act as a harmonizing herb that can moderate and balance the effects of other herbs (and non-herbs) in an herbal formulation. It can also be selected because it can mildly act to detoxify the body, which may prevent unwanted reactions and caffeine toxicity.

In at least one third exemplary embodiment, herbal formulations including one or more of Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis are disclosed. In at least one exemplary embodiment, herbal formulations can be prepared to mitigate the undesired effects of caffeine when consumed/ingested using, for example, caffeinated beverages as the medium for administration. Herbal formulations may accomplish one or more of reduce the increased risk of bone loss, reduce the increased risk of sterility, balance acidic body pH and mitigate premature aging, among other potential benefits. Herbal formulations can be formulated as a “tonic” for general wellness that can be suggested for daily administration, akin to a daily multivitamin.

The following one or more exemplary embodiments include all of Radix Rehmannia Preparata, Rhizoma Dioscoreae, Fructus Corni, Rhizoma Polygonati, Radix Polygoni Multiflori, Pericarpium Citri Reticulatae, Pericarpium Citri Reticulatae, Radix Codonopsis, Glycyrrhiza uralensis and Cordyceps sinensis in the following proportions.

TABLE 3

| Herb | % of formulation by weight |
|---|---|
| Radix Rehmannia Preparata | 10-40 |
| Rhizoma Dioscoreae | 05-20 |
| Fructus Corni | 02-10 |
| Rhizoma Polygonati | 10-40 |
| Radix Polygoni Multiflori | 05-35 |
| Glycyrrhiza uralensis | 02-15 |
| Cordyceps sinensis | 02-15 |

In at least one exemplary embodiment, a therapeutic amount (dosage) of an herbal formulation can be between about 0.5 and 1.5 grams per eight to twelve ounces of conventional “drip” coffee. Furthermore, a therapeutic amount of an herbal formulation can be about one gram per eight to twelve ounces of conventional “drip” coffee. Herbal formulations prepared as described directly above may less-than-substantially alter the flavor characteristics of conventional coffee beverages. For example, when provided to eight to twelve ounces of conventional “drip” coffee, the taste characteristics of the coffee beverage can only be slightly altered, if at all, as discernable by the typical human sense of taste.

In accordance with the teachings of TCM, Radix Rehmannia Preparata (shu di huang), Rhizoma Dioscoreae (shan yao) and Fructus Corni (shan zhu yu) are the base of the traditional formulation Liu Wei Di Huang Tang, which acts to nourish the kidneys, adrenals and overall energy processes. Liu Wei Di Huang Tang can act to reduce the likelihood of osteoporosis, mitigate premature aging and reduce the likelihood of sterility. Two other herbs—Poria and Alisma Orientale—of Liu Wei Di Huang Tang are diuretics and can be omitted because coffee is a diuretic. The last herb, Paeonia Moutan, is contraindicated during pregnancy and can be omitted to prevent unwanted effects.

In accordance with the teachings of TCM, Rhizoma Polygonati (huang jing) acts to provide a deeper and longer lasting energy boost than caffeine and stimulants generally. It is considered a restorative herb and can be selected to increase mental alertness and/or to reduce physical fatigue.

In accordance with the teachings of TCM, Radix Polygoni Multiflori (he show wu) acts as an anti-aging agent. It is traditionally considered one of TCM's premier anti-aging herbs and can be selected for that reason.

In accordance with the teachings of TCM, Pericarpium Citri Reticulatae (chen pi) acts to promote digestion of some herbs that act to nourish kidneys, such as Radix Rehmannia Preparata. Pericarpium Citri Reticulatae can be selected to counteract difficulties in digestion resulting from the cloying nature (ingredient) of some herbs.

In accordance with the teachings of TCM, Radix Codonopsis (dang shen) can act to promote digestion, promote absorption, promote metabolism, reduce fatigue and strengthen the immune system. It can be selected for such reasons.

In accordance with the teachings of TCM, Glycyrrhiza uralensis (gan cao) is one of, if not the most, commonly used herb in Chinese herbal medicine. It is believed to act as a harmonizing herb that can moderate and balance the effects of other herbs (and non-herbs) in an herbal formulation. It can also be selected because it can mildly act to detoxify the body, which may prevent unwanted reactions and caffeine toxicity.

In accordance with the teachings of TCM, Cordyceps sinensis (dong chong xia cao) acts to strengthen the immune system, increase resistance to disease, increase athletic performance and endurance, counteract sexual disorders, increase sperm count, improve lung function, counteract respiratory disorders, decrease high blood pressure, lower cholesterol, improve kidney and adrenal functions, inhibit the growth of at least some cancer cells, increase collagen growth and improve arterial health. It can be selected for such reasons.

In at least one fourth exemplary embodiment, herbal formulations including one or more of Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae are disclosed. In at least one exemplary embodiment, herbal formulations can promote healthy reactions to stress when consumed/ingested using, for example, caffeinated beverages as the medium for administration. Herbal formulations may accomplish one or more of having a calming effect on the mind and assisting in the body's reaction to stressful environments, among other potential benefits.

The following one or more exemplary embodiments include all of Semen Zizyphi Spinosae, Ramulus Uncariae cum Uncis, Radix Paeoniae Alba, Bulbus Lilii, Albizzia julibrissin, Ganoderma lucidum, Glycyrrhiza uralensis and Spica prunellae in the following proportions.

TABLE 4

| Herb | % of formulation by weight |
|---|---|
| Semen Zizyphi Spinosae | 10-30 |
| Ramulus Uncariae cum Uncis | 15-50 |
| Radix Paeoniae Alba | 05-20 |
| Bulbus Lillii | 20-50 |
| Albizzia julibrissin | 08-30 |
| Ganoderma lucidum | 05-20 |
| Glycyrrhiza uralensis | 03-15 |
| Spica prunellae | 03-15 |

In at least one exemplary embodiment, a therapeutic amount (dosage) of an herbal formulation can be between about 0.5 and 1.5 grams per eight to twelve ounces of conventional “drip” coffee. Furthermore, a therapeutic amount of an herbal formulation can be about one gram per eight to twelve ounces of conventional “drip” coffee. Herbal formulations prepared as described directly above may less-than-substantially alter the flavor characteristics of conventional coffee beverages. For example, when provided to eight to twelve ounces of conventional “drip” coffee, the taste characteristics of the coffee beverage may not be discernably altered, at least not easily, by the typical human sense of taste.

In accordance with the teachings of TCM, Semen Zizyphi Spinosae (suan zao ren) acts as a mild sedative, particularly when roasted. Roasting can also assist in mimicking or blending with the flavor characteristics of coffee beverages. It can be selected for such reasons.

In accordance with the teachings of TCM, Ramulus Uncariae cum Uncis (gout eng) acts to counteract trembles, shakes, spasms, jifters and the like. It can be selected because it may counteract headaches, hypertension, anxiety, high blood pressure and other symptoms typically associated with people having high stress levels. It can also be selected to counteract temporary trembles and like conditions from caffeine consumption.

In accordance with the teachings of TCM, Radix Paeoniae Alba (bai shao) acts to mitigate (or moderate) the undesired effects of traditional stimulating herbs, which can be similar in character to the undesired effects of caffeine consumption. It can be selected to mitigate the undesired effects of caffeine consumption based upon the same traditional principles.

In accordance with the teachings of TCM, Bulbus Lilii (bai he) acts to counteract heart palpitations, irritability and restlessness. It also has little to no flavor. It can be selected for such reasons.

In accordance with the teachings of TCM, Albizzia julibrissin (he huan hua) acts as an antidepressant. It can be selected for this reason.

In accordance with the teachings of TCM, Ganoderma lucidum (ling zhi, reishi mushroom) acts to increase memory (reduce forgetfulness), counteract insomnia and increase immune system function. It also is bitter in taste, and can be selected for the above reasons and its ability to blend with the flavor characteristics of coffee beverages.

In accordance with the teachings of TCM, Glycyrrhiza uralensis (gan cao) is one of, if not the most, commonly used herb in Chinese herbal medicine. It is believed to act as a harmonizing herb that can moderate and balance the effects of other herbs (and non-herbs) in an herbal formulation. It can also be selected because it can mildly act to detoxify the body, which may prevent unwanted reactions and caffeine toxicity.

In accordance with the teachings of TCM, Spica prunellae (xia ku cao) generally is believed to have a cooling nature opposite of coffee beverages and can reduce high blood pressure. It can be selected for such reasons.

In accordance with at least one fifth exemplary embodiment, herbal formulations including one or more of Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae are disclosed. In at least one exemplary embodiment, herbal formulations can improve immune system functions when consumed/ingested using, for example, caffeinated beverages as the medium for administration. Herbal formulations may strengthen/boost the immune system and responses, among other potential benefits. Particularly, herbal formulations may strengthen the immune response during times of infection with the common cold and influenza and by preventing reoccurrences of common cold and influenza infections.

The following one or more exemplary embodiments include all of Ramulus Uncariae cum Uncis, Radix Astragali, Radix Codonopsis, Fructus Arctii, Folium Istatidis, Lasiosphaera seu Calvatia, Glycyrrhiza uralensis, Fructus Forsythiae and Flos Lonicerae in the following proportions.

TABLE 5

| Herb | % of formulation by weight |
|---|---|
| Ramulus Uncariae cum Uncis | 20-60 |
| Radix Astragali | 10-40 |
| Radix Codonopsis | 10-40 |
| Fructus Arctii | 05-30 |
| Folium Istatidis | 05-30 |
| Lasiosphaera seu Calvatia | 05-20 |
| Glycyrrhiza uralensis | 05-20 |
| Fructus Forsythiae | 05-20 |
| Flos Lonicerae | 05-20 |

In at least one exemplary embodiment, a therapeutic amount (dosage) of an herbal formulation can be between about 0.5 and 1.5 grams per eight to twelve ounces of conventional “drip” coffee. Furthermore, a therapeutic amount of an herbal formulation can be about one gram per eight to twelve ounces of conventional “drip” coffee. Herbal formulations prepared as described directly above may less-than-substantially alter the flavor characteristics of conventional coffee beverages. For example, when provided to eight to twelve ounces of conventional “drip” coffee, the taste characteristics of the coffee beverage may not be discernably altered, at least not easily, by the typical human sense of taste.

In accordance with the teachings of TCM, Ramulus Uncariae cum Uncis (gou teng) acts to counteract trembles, shakes, spasms, jitters and headaches, which may be symptoms of the common cold. It can be selected for such reasons.

In accordance with the teachings of TCM, Radix Astragali (huang qi) is considered to be one of the premier herbs for strengthening the immune system. It can be selected for that reason.

In accordance with the teachings of TCM, Radix Codonopsis (dang shen) acts to support the actions of Radix Astragali, thus, acting to support strengthening the immune system by promoting digestive health and nutrient absorption. It can be selected for such reasons.

In accordance with the teachings of TCM, Fructus Arctii (niu bang zi) acts to boost the immune system and, particularly, to relieve a sore throat and/or tonsillitis. It is considered an antiviral agent. It can be selected for such reasons.

In accordance with the teachings of TCM, Folium Istatidis (da qing ye) acts to counteract early-stage febrile disorders that may have symptoms such as fever, sore throat and chills. It can also act to fight infection because it is considered an antiviral agent. It can be selected for such reasons.

In accordance with the teachings of TCM, Glycyrrhiza uralensis (gan cao) is one of, if not the most, commonly used herb in Chinese herbal medicine. It is believed to act as a harmonizing herb that can moderate and balance the effects of other herbs (and non-herbs) in an herbal formulation. It can also be selected because it can mildly act to detoxify the body, which may prevent unwanted reactions and caffeine toxicity.

In accordance with the teachings of TCM, Fructus Forsythiae (lian qiao) and Flos Lonicerae ain yin hua) act together to counteract symptoms of the common cold and influenza. Both are considered to have antiviral properties and are believed to act best when used together. They can be selected for such reasons.

In any of the above exemplary embodiments, additional herbs can be added, which can include: Radix Saposhnikoviae (fang feng, siler root), Flos Chrysanthemi (Ou hua, chrysanthemum flower), Fructus Viticis (man jing zi, vitex fruit), Radix Bupleurum, Chinensis (chai hu, bupleurum root), Rhizoma cimicifugae (sheng ma, cimicifuga root), Radix Anemarrhenae (zhi mu, anemarrhena root), Rhizoma Phragmitis (lu gen), Fructus Gardeniae (zhi zi, gardenia fruit), Radix Scutellariae (huang qin, baikal sculicap), Radix Rehmannia (sheng di huang, raw rehmannia root), Radix Istaditis (ban Ian gen, woad root), Cortex Lycii (di gu pi, lycii root bark), Radix gentianae macrophyllae (qin jiao), Herba Taxilli (sang ji sheng, loranthus twig), Cortex Acanthopanacis (wu jia pi), Poria (fu ling), Fructus Crataegi (shan zha, hawthorn fruit), and Radix Panacis Quinquefolii (xi yang shen, American ginseng), among others.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A composition for provisioning to a caffeinated beverage, comprising:
an herbal formulation including three or more medicinal herbs selected from the group consisting of Ganoderma lucidum, Semen Zizyphi Spinosae, Herba Cistanches, Gastrodia Elata and Rhizoma Polygonati.

2. The composition of claim 1 wherein the herbal formulation includes four or more medicinal herbs selected from the group consisting of Ganoderma lucidum, Semen Zizyphi Spinosae, Herba Cistanches, Gastrodia Elata and Rhizoma Polygonati.

3. The composition of claim 1 wherein the herbal formulation comprises Ganoderma lucidum, Semen Zizyphi Spinosae, Herba Cistanches, Gastrodia Elata and Rhizoma Polygonati.

4. The composition of claim 1 further comprising:
one or more ingestible non-herbal materials.

5. The composition of claim 1 wherein the herbal formulation is embodied in one of a capsule, a tablet, a pill, a tincture, a bag, an injection, a powder, a granule extract and a liquid extract.

6. The composition of claim 1 wherein the medicinal herbs of the herbal formulation are selected to improve cognitive functionality.

7. The composition of claim 1 wherein the herbal formulation is selected so as to not substantially alter one or more flavor characteristics of the caffeinated beverage.

8. The composition of claim 1 wherein an amount of Ganoderma lucidum is between about 15 and 65 percent by weight.

9. The composition of claim 1 wherein an amount of Semen Zizyphi Spinosae is between about 5 and 30 percent by weight.

10. The composition of claim 1 wherein an amount of Herba Cistanches is between about 4 and 15 percent by weight.

11. The composition of claim 1 wherein an amount of Gastrodia Elata is between about 5 and 15 percent by weight.

12. The composition of claim 1 wherein an amount of Rhizoma Polygonati is between about 5 and 15 percent by weight.

13. The composition of claim 1 wherein a therapeutic amount of the herbal formulation is between about 0.5 and 1.5 grams.

14. The composition of claim 1 wherein a therapeutic amount of the herbal formulation is about 1 gram.

15. A caffeinated composition, comprising:
an herbal formulation including Ganoderma lucidum, Semen Zizyphi Spinosae, Herba Cistanches, Gastrodia Elata and Rhizoma Polygonati; and
a caffeinated beverage, the herbal formulation provided in the caffeinated beverage.

16. The caffeinated composition of claim 15 wherein the herbal formulation is provided in the caffeinated beverage by substantial dissolution.

17. The caffeinated composition of claim 15 wherein the caffeinated beverage is a coffee beverage.

18. A method of providing an herbal formulation to a caffeinated beverage, comprising:
preparing an herbal formulation, the herbal formulation including Ganoderma lucidum, Semen Zizyphi Spinosae, Herba Cistanches, Gastrodia Elata and Rhizoma Polygonati; and
adding the herbal formulation to a caffeinated beverage.

19. The method of claim 18, further comprising:
dissolving, at least substantially, the herbal formulation in the caffeinated beverage.

20. The method of claim 18 wherein the caffeinated beverage is a coffee beverage.
